(19) United States
(12) Patent Application Publication
(10) Pub. No.: US 2021/0349892 A1
(43) Pub. Date: Nov. 11, 2021

(54) SYSTEM AND METHOD FOR IMPROVING SEARCHING OF STORED DATA

(71) Applicant: Yijun Du, Scarborough (CA)

(72) Inventor: Yijun Du, Scarborough (CA)

(21) Appl. No.: 17/277,867

(22) PCT Filed: Oct. 25, 2018
(86) PCT No.: PCT/CA2018/051350

§ 371 Date: Mar. 19, 2021

(51) Int. Cl. G06F 16/242; G06F 3/0482

(52) U.S. Cl. CPC G06F 16/2428; G06F 16/2425; G06F 3/0482

(57) ABSTRACT

Described is a computer-implemented method for presenting a search session of a storage tree and associated collection of data items to a user. A search query is received from a user containing one or more terms or non-term conditions for searching the storage tree and associated data items. A search tree representation of the storage tree and associated data items is created, which contains a set of nodes including a first parent node representing the search query. A search query modification request is made, and the search tree representation is modified to add a first tier first child node to the set of nodes which represents the first search query modification. The search tree representation is further modified to add a first-tier unsorted child node to the set of nodes which represents the search query less the first search query modification and then the search tree representation is output.

### FIELD OF THE INVENTION

The present specification relates generally to search interfaces, and specifically to a search interface for searching through hierarchically structured storage.

### BACKGROUND OF THE INVENTION

Many computer systems include static hierarchical file managing and file browsing interfaces. Such interfaces are often provided to break large data sets into subsets to make using the data more manageable for a human user. Such interfaces are often used by users of the computer systems to search for and retrieve data, including file and folder information.

Static hierarchical storage structures or trees can be very handy for human users. Many users are intuitively able to understand such a default structure as it is analogous to the way the physical world is set up; with objects and items often found in one predictable location which can be accessed by taking a number of predictable steps. Such structures often allow users to apply their experience to find data or to decide where to store new data. Such structures are often designed so that new users can readily understand the relationships between folders and subfolders and navigate the structure to locate data of interest. Such static hierarchical structures also result in a ‘path’ of folders and subfolders which can be used to uniquely identify locations in the structure.

However, file management and browsing interfaces remain little changed from when they were first introduced. Users are largely still forced to find and retrieve data through static hierarchical interfaces. Hierarchical static structures may be efficient for storing data but can be difficult to use for data retrieval or to indicate multiple ways of classifying data, particularly when the dataset becomes quite large.

### SUMMARY OF THE INVENTION

In accordance with an aspect of the invention, there is provided a non-transient computer-readable medium containing computer-readable instructions which, when executed by a computer processor, perform a method of: receiving from a user an electronic search query in a computer, the search query containing one or more terms or non-term conditions for searching through a storage tree and associated collection of data items; creating in the computer a search tree representation of the storage tree and associated collection of data items, the search tree representation containing a set of nodes including a first parent node representing the search query; receiving from the user an electronic first search query modification request in the computer, the first search query modification request modifying the search query to add a first term or non-term condition; modifying the search tree representation in the computer to add a first tier first child node to the set of nodes, the first tier first child node connected to the first parent node and representing the first search query modification; and automatically updating the search tree representation in the computer to add an at least one first tier unsorted child node to the set of nodes, the at least one first tier unsorted child node connected to the first parent node and representing the search query less the first search query modification.

According to a further aspect of the invention, there is provided a computer-implemented method for presenting a search session of a storage tree and associated collection of data items to a user, comprising executed on a processor the steps of: receiving from the user an electronic search query in a computer configured to be able to access the storage tree and associated collection of data items and configured to be able to access a display, the search query containing one or more terms or non-term conditions for searching through the storage tree and associated collection of data items; creating in the computer a search tree representation of the storage tree and associated collection of data items, the search tree representation containing a set of nodes including a first parent node representing the search query; receiving from the user an electronic first search query modification request in the computer, the first search query modification request modifying the search query to add a first term or non-term condition; modifying the search tree representation in the computer to add a first tier first child node to the set of nodes, the first tier first child node connected to the first parent node and representing the first search query modification; modifying, without receiving from the user a further electronic request, the search tree representation in the computer to add an at least one first tier unsorted child node to the set of nodes, the at least one first tier unsorted child node connected to the first parent node and representing the search query less the first search query modification; and outputting the search tree representation.

According to a further aspect of the invention, there is provided a system for presenting a user interface, comprising: at least one data memory storing a storage tree and associated collection of data items, the storage tree and associated collection of data items including a set of files and a set of folders; at least one processor electronically coupled to the data memory for processing the set of files and the set of folders; and a display for presenting a search tree representation, and wherein the at least one processor is configured to receive the first search query for searching the storage tree and associated collection of data items, to generate a search tree representation including a root node representing the first search query, to receive a first search query modification of the first search query, to modify the search tree representation to include a first tier first sorted child node representing the first search query modified by the first search query modification, to modify the search tree representation to include a first tier first unsorted child node representing the first search query less the first search query modified by the first search query modification, and to output the search tree representation.

Other aspects and features according to the present application will become apparent to those ordinarily skilled in the art upon review of the following description of embodiments of the invention in conjunction with the accompanying figures.

### BRIEF DESCRIPTION OF THE DRAWINGS

The principles of the invention may better be understood with reference to the accompanying figures provided by way of illustration of an exemplary embodiment, or embodiments, incorporating principles and aspects of the present invention, and in which:

FIG. 1 shows a screenshot of a display panel, according to an embodiment;

FIG. 2 shows a screenshot of a search tree representation, according to an embodiment;

FIG. 3 shows a screenshot of a compact storage tree, according to an embodiment;

FIG. 4 shows a screenshot of a prior art compact storage tree;

FIG. 5 shows a screenshot of a compact storage tree according to the embodiment of FIG. 3, with an expanded storage tree dropdown;

FIG. 6 shows a screenshot of a search tree representation, according to an embodiment;

FIG. 7 shows a screenshot of the search tree representation of FIG. 6, showing further details in a mouseover or popup window;

FIGS. 8A, 8B, and 8C show screenshots of search tree representations indicating overlapping results, each according to an embodiment;

FIG. 9 shows a screenshot of a storage tree, according to an embodiment;

FIG. 10 shows a screenshot of a search tree representation, according to an embodiment;

FIG. 11 shows a screenshot of a results listing, according to an embodiment;

FIG. 12 shows a screenshot of the results listing of FIG. 11, in which the results are grouped according to a set of grouping criteria;

FIG. 13 shows a screenshot of the results listing of FIG. 12, in which the results have been further grouped according to a set of grouping criteria;

FIG. 14 shows a screenshot of the results listing of FIG. 13, in which a group of results has been collapsed;

FIG. 15 shows a screenshot of the results listing of FIG. 13, in which all groups of results have been collapsed;

FIG. 16 shows a schematic diagram of a screenshot of the results listing of FIG. 13 and a screenshot of a projection of the results listing of FIG. 13, according to an embodiment;

FIG. 17 shows a screenshot of a list of search tree adjustment options in association with a search tree, according to an embodiment;

FIG. 18 shows a screenshot of a list of search tree adjustment options in association with a search tree, according to an embodiment;

FIG. 19 shows a screenshot of a list of search tree adjustment options in association with a search tree, according to an embodiment;

FIG. 20 shows a screenshot of a details subpanel in association with a listing of results, according to an embodiment;

FIG. 21 shows a screenshot of a details subpanel in association with a listing of results, according to an embodiment;

FIGS. 22A to 22J show screenshots of stages in the construction of a search tree representation during a ‘show’ mode of operation, according to an embodiment;

FIGS. 23A to 23E show screenshots of stages in the construction of a search tree representation during an ‘exclude’ mode of operation, according to an embodiment;

FIG. 24 is a flow diagram of steps in the creation of a search tree representation, according to an embodiment;

FIG. 25 is a schematic diagram of a system for generating a search tree representation, according to an embodiment; and

FIG. 26 is a schematic diagram of a computer search tree representation generation system, according to an embodiment.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly depict certain features of the invention.

Data, data items, and data collections are often associated with static representation and retrieval structures, such as storage folder hierarchies or storage trees. However, the retrieval and management of data, data items, and data collections often benefits from non-static representation and retrieval structures. For example, different files may need to be shown together at different times or for different users. In another example, static structures mean that a non-intuitively located piece of data may be difficult to find, particularly for a user who is unfamiliar with the structure, and there is also little opportunity for each user of a static structure to customize the location representation of a piece or item of data without duplicating the storage of that piece or item of data. In another example, it can be difficult to choose a location for a piece of data which could fit in a number of storage locations, particularly where the descriptions of those storage locations appear mutually exclusive, and it can be difficult for a user to know where to find it once it has been stored somewhere.

Building multiple structures for the same data collection can solve some of the problems of a static structure, but can cause other difficulties such as increasing the storage requirements of a storage system and synchronizing multiple physical copies of the same data between multiple locations when the data or the storage trees need to be updated. As an alternative, an interface can be provided which adds an extra layer between a user and the storage structure in which they are searching without impacting any part of the storage structure; a search tree may thus provide an additional logical representation of a storage tree and the set or collection of data or data items or data pieces associated with the storage tree.

An aspect of this description relates to a search interface for use in searching for and representing data or data items which are stored in a storage tree structure, such as for searching within and representing a folder tree file storage structure and associated data collection. A further aspect of this description relates to a search interface allowing a user to create a search tree which preserves search history and divides a data collection hierarchically—thereby preserving many of the benefits of a hierarchical navigation system while providing a customizable and retraceable representation of a location or of a piece or collection of data.

Embodiments of the disclosed invention relate to a search interface which allows a user to form a search tree representation made of a root node or first parent node and one or more layers of child nodes, with each layer containing at least one set of child nodes corresponding to a common node of the preceding layer. In some embodiments, the root node or first parent node is formed to represent an incipient search query containing at least one term or non-term condition. In some embodiments, each set of child nodes includes at least one sorted child node representing the search of the parent node refined by the addition of at least one term or non-term condition, and each set of child nodes also includes at least one unsorted child node representing the search of the parent node less the modified version of the search represented by sorted child nodes. In some embodiments, the interface allows for the display of metadata associated with each node of the search tree representation, including the display of file count, file duplication, and update status metadata.

Embodiments of the disclosed invention relate to a search interface which allows a user to view a one-dimensional listing of search results returned by a specific search, and to further group or flag results in the one-dimensional listing based on sub-searches or based on the position of the results in an associated storage tree or an associated search tree representation.

Further embodiments of the disclosed invention relate to a search interface which allows for the collapse of a typical folder tree structure into a compact path representation or compact storage tree representation, in order to free up display space for the display of a search tree representation or other details. In some embodiments, the compact storage tree representation includes the name of the folder in which the search is being performed, with the text of other hierarchically preceding parent nodes replaced by icons, such as dropdown icons, in order to provide a more vertically and horizontally compressed representation. In some embodiments, the compact storage tree representation indicates the folder in which a search is being performed or the folder in which a selected data item is located, such as via highlighting. In some embodiments, the interface also permits a user to toggle between the compact storage tree representation and a more fulsome storage tree depiction.

Further embodiments of the disclosed invention relate to an interface which allows a user to add, to remove, or to modify a common tag or common tags to each result of a set of selected results.

Further embodiments of the disclosed invention relate to an ‘exclusion’ search mode, where search requests are treated as queries ‘for exclusion’; users are presented with the unsorted portion of a searched data collection and are able to reduce the unsorted portion by further ‘exclusion’ queries, such as until there are no further unsorted results. An exclusion mode may be particularly helpful in providing a smoother and more efficient workflow for reorganizing large and complex data collections. For example, instead of a user being presented with the corresponding results upon executing a refinement search from a parent node, they are instead presented with the search results for the unsorted child node or unsorted child nodes resulting from the refinement search; this may better enable a user to identify and form further ‘exclusion’ queries by reviewing the unsorted results or sampling a residue item or items from the reduced unsorted results list, this may also allow a user to immediately see when no further exclusion searches are needed by noting that no further results fall under the unsorted node or nodes. In some embodiments, an interface is also included to permit a user to toggle between a normal search mode and an ‘exclusion mode’, such as via keyboard input or dedicated buttons.

In some embodiments a search tree representation may represent more than one storage tree and associated data collection, and in some embodiments may represent or include any searchable collection of data.

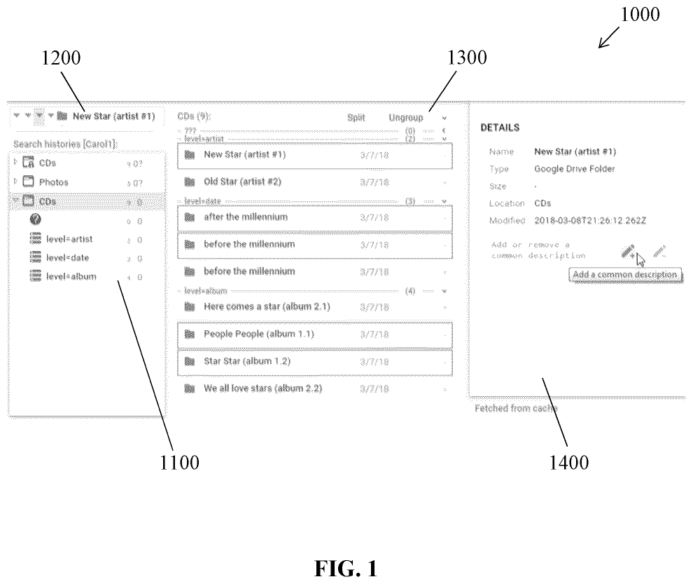

A screenshot of an embodiment of a data management interface 1000 is shown in FIG. 1. Screenshot 1000 of the data management interface shows a display panel which includes a search subpanel 1100 to show an output display of a search tree representation, a storage subpanel 1200 to show an output display of a storage tree, a list subpanel 1300 to show an output display of a collection of search results, and a details subpanel 1400 to show an output display of details about a selected search result or results. The data management interface provides a combination of features for convenient file management, browsing, and use.

A search tree representation stores user searches in a hierarchical and retraceable format, which, in some embodiments, may be browsed like a storage tree and may be stored for future use in finding a result. In some embodiments the search tree representation may be saved, modified and customized, and exported.

Search queries, such as queries represented as nodes in a search tree representation, may be search terms such as words or symbols, or they may be non-term conditions such as value ranges, or they may be a combination of terms and non-term conditions.

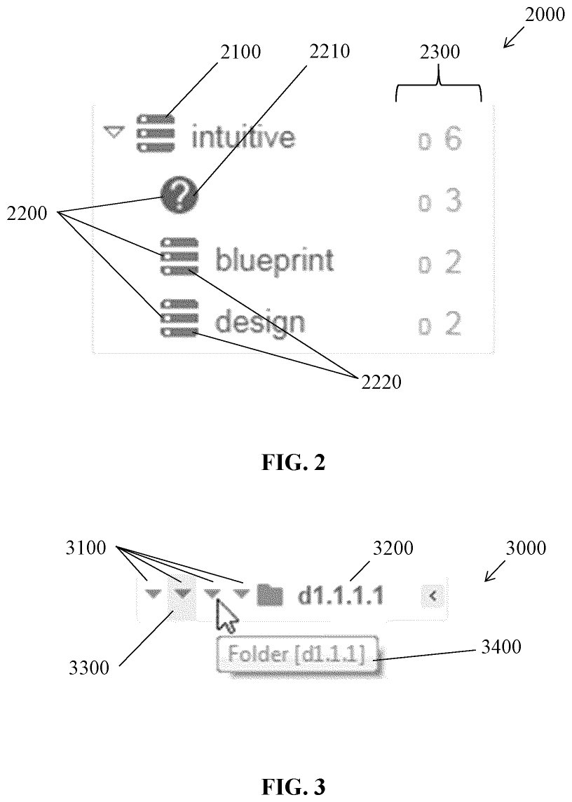

A screenshot of the display of an example search tree representation 2000 is shown in FIG. 2. Search tree representation 2000 includes one parent node 2100 and three child nodes 2200. Parent node 2100 represents an incipient search while the child nodes 2200 represent subdivisions of the incipient search. Child nodes 2200 are all at the same hierarchical level and may each themselves have a set of child nodes. The set of child nodes 2200 of parent node 2100 define the entirety of the parent node 2100 by including an unsorted child node 2210 defining everything that is not defined by sorted nodes 2220. In some embodiments, a set of child nodes may include more than one unsorted child nodes, as detailed further below.

A search tree representation may be formed when a user searches through a data storage using a first search query and then refines the first search query by adding a second search term or non-term condition to the first search query to narrow down the set of results returned or represented. The first search query is represented by a parent node, such as parent node 2100, while the first search query as modified by the second search term or non-term condition may be represented by a sorted child node, such as child node 2220. In forming a sorted child node using a second search term or non-term condition, the search tree representation may be automatically provided with an unsorted child node to define the inverse of the sorted child node, such as unsorted child node 2210.

As indicated in TABLE 1 below, if a parent node represents a search in a data collection for data items matching the term ‘intuitive’, a set of child nodes may designate divisions in the data items returned by the parent node search. The two sorted child nodes designate divisions based on the qualifiers ‘blueprint’ and ‘design’, respectively, resulting in the three child nodes ‘intuitive AND blueprint’, ‘intuitive AND design’, and ‘intuitive AND (NOT (blueprint OR design))’.

TABLE 1
Table representation of a search tree representation

| | | |
|---|---|---|
| | (1) intuitive | |
| (2) intuitive AND | (3) intuitive AND | (4) intuitive |
| (NOT (blueprint | blueprint | AND design |
| OR design)) | | |

As indicated in TABLE 2, below, the set of three child nodes of TABLE 1 exhaustively defines the data collection defined by the parent node of TABLE 1.

TABLE 2
Search tree representation

| | | | | |
|---|---|---|---|---|
| (2) intuitive AND | OR | (3) intuitive | OR | (4) intuitive |
| (NOT (blueprint OR design)) | | AND blueprint | | AND design |
| | | = | | |
| | | (1) intuitive | | |

The inclusion of an unsorted residue node designating all results not returned by equal-level sorted nodes allows each level and sublevel to represent the complete collection at any defined level of granularity without any items of the collection defined by the topmost parent node to be unreachable or unrecognizable. Any searchable collection of data, such as on a computer system, can thus be divided and managed using such a representation.

By storing search tree representations for later reference, a user can define an organizational structure according to their own needs and desires, and can modify the representation when they wish without needing to move or duplicate stored data of the data collection represented by the search tree representation.

The use of an unsorted child node is important in improving the search tree representation for use as a savable and reusable file management structure. Without an automatically added unsorted node, files may be inadvertently lost or suppressed when a parent node is split into child nodes. While a user could manually define an unsorted node as the inverse of any defined child nodes, the automated creation and the automated updating of an unsorted node assists in easily and accurately managing a data collection, particularly when a search tree representation contains multiple sorted child nodes.

The separation of the underlying hierarchical storage structure and the logical retrieval structure or search tree allows for a great deal of additional flexibility and the building of different search session trees for different retrieval paths in parallel on the same data collection.

Folder results from a storage tree may be a particularly important result returned by a search tree representation of a storage tree and associated collection of data items. In a typical management system or structure, the number of nodes in a hierarchical structure can be difficult to determine, which can make it difficult to determine if there is further information hidden somewhere that is otherwise unlocated. By including folders in the search results returned, the search tree representation is able to show a more fulsome picture of a storage tree and associated collection of data items. In some embodiments a search tree representation may represent only files returned by the search queries or nodes, in some embodiments a search tree representation may represent only folders of a storage tree representation returned by the search queries or nodes, while in many embodiments a search tree representation may represent both folders of a storage tree representation and files stored in the storage tree.

While the storage tree may be presented and used alone, many additional benefits are provided by, in some embodiments, modifying the overall interface to include both a fulsome dynamic hierarchical search tree representation and a static hierarchical storage structure in a common display panel. Although in some embodiments, the usual storage tree representation may be collapsed to increase the display space which can be dedicated to other tools and representations, as depicted in storage subpanel 1200 of display 1000 of FIG. 1.

As both a storage tree structure and search tree representation allow users to navigate through document collections in a similar way, the static storage structure may become less important for navigation than the more dynamic and adjustable search tree representation structure. However, a user may still wish to have access to the structure and to details regarding the storage location of a particular piece of data. In this case, collapsing the normal folder tree storage structure into a compact form may save display space and free up space for the display of the search tree representation while still allowing a user to keep track of their location within the folder tree storage structure.

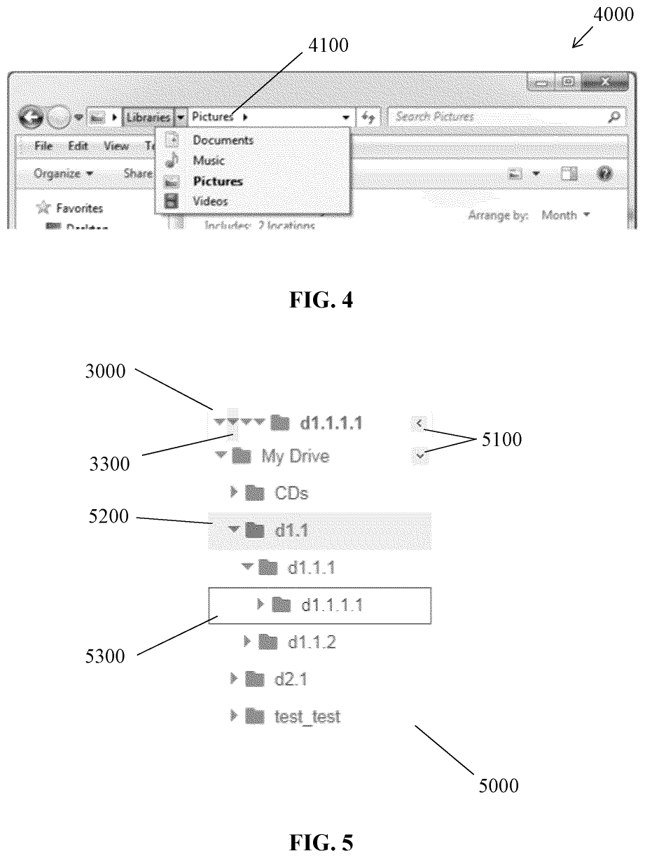

An example compact storage tree representation 3000 is depicted in FIG. 3. Collapsed storage tree representation 3000 is sized to fit the space provided by storage panel 1200 of interface 1000 to free up further space for search panel 1100.

Collapsed storage tree representation 3000 shows icons 3100 indicating hierarchically preceding parent nodes of a represented storage tree down to a given folder, with the given folder indicated by the folder name in folder space 3200. In some embodiments, the collapsed storage tree representation may provide further information via highlighting, popups, or other indicators.

As indicated in TABLE 3, below, a collapsed display of a storage tree structure can occupy a space having reduced dimensions, such as a greatly reduced vertical dimension. The collapsed form can also be displayed in one or more ways, such as displaying the file path up to the storage folder in which the search is performed, as shown in the example in the left column of TABLE 3, or by displaying the file path up to the storage folder in which a piece of data selected by a user is located, as shown in the example in the right column of TABLE 3 which also has highlighted the icon of the folder in which the search is performed.

TABLE 3
Reduced size of a collapsed display embodiment

| | | |
|---|---|---|
| | | Both folder being searched and |
| | Folder being searched | folder currently selected by user |
| Compact mode | [symbol] d1.1 | [symbol] d1.1.1.1 |
| presentation | | |
| Regular | [symbol] | [symbol] |
| folder tree | [symbol] | [symbol] |
| presentation | | |

[symbol]

indicates data missing or illegible when filed

Different display options may be available to different users and in different situations. For example, where a search has returned a number of results, the collapsed storage tree representation may show only up to the deepest common parent node as indicated on the left of TABLE 3. However, where the user has selected one or more of the results of a search, the section may be in a deeper folder in a storage tree, and the collapsed storage tree representation may be expanded as on the right of TABLE 3 to indicate both the location of the search and the location of the selected result or results. In other embodiments other information may be indicated by the collapsed storage tree representation.

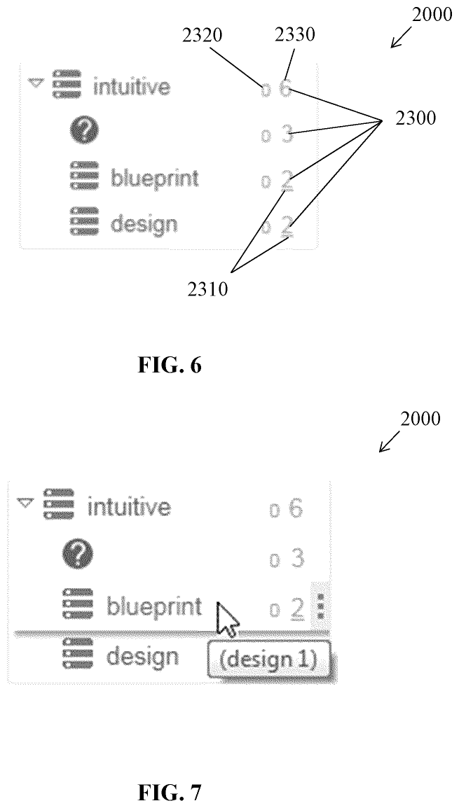

While existing file manager system displays, such as example display 4000 of FIG. 4, provide for a ‘breadcrumb’ display option for displaying a storage tree, such as path 4100, the display of FIG. 3 is more compact in that all the leading folder names are omitted and indicated by dropdown icons 3100, one or more of which may be highlighted, such as icon 3300 of FIG. 3, to provide information to the user, such as to indicate where in the structure the user's search tree representation is searching within. Because the user is navigating through the data collection using a search tree representation, the representation of the storage tree can be more compact then would otherwise be practical. In the embodiment shown in FIG. 3, a user can also retrieve further information such as the name of a parent folder via a popup 3400 in response to a mouseover event if they desire.

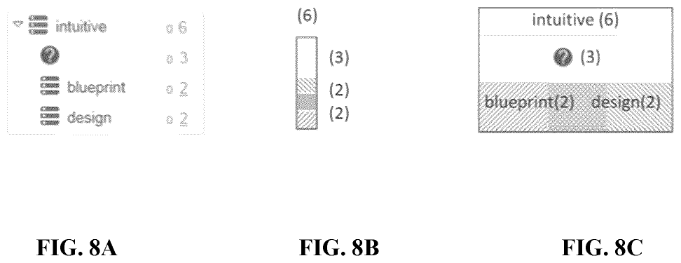

In some embodiments, a collapsed storage tree representation can be transitioned by a user into a more fulsome storage tree representation, such as when further information is desired. As shown in FIG. 5, collapsed storage tree representation 3000 may be transitioned to storage tree representation 5000. A user may be provided with a transition trigger, such as dropdown icon 5100, which can be used to cause storage tree representation 5000 to be presented. Storage tree representation 5000 may be presented in a variety of ways, such as a pop-up style appendage to collapsed storage tree representation 3000, as a replacement of collapsed storage tree representation 3000 in a display panel, or as an expansion of collapsed storage tree representation 3000 fitting into or extending a display panel provided for the collapsed storage tree representation 3000.

Like collapsed storage tree representation 3000, storage tree representation 5000 can also indicate dynamic properties, such as which folder of the storage tree is the one that the search tree representation is searching within and which folder of the storage tree is the one that a file or other piece of data that the user has selected is stored within. Storage tree representation 5000 of FIG. 5 indicates the search tree representation is in a second level folder as indicated by highlighted folder representation 5200, much as is represented by the highlighting of highlighted icon 3300 of collapsed storage tree representation 3000. Storage tree representation 5000 also indicates that as selected item of data is in a fourth level folder by framing the folder representation 5300 with a selection box.

For many users, as part of common managing tasks, easy access to metadata and information about a collection of data items as a whole is important, in addition to ready access to individual data items. For example, a user may wish to know how many albums they have associated with artist X, and how many songs they have associated with artist X.

The direct association of metadata with a search tree representation is of particular benefit as it allows user to receive overview information of a collection at a glance and can indicate characteristics of particular tree nodes distinctive to search trees. Such information can be important both in navigating a search tree representation and in creating a search tree representation.

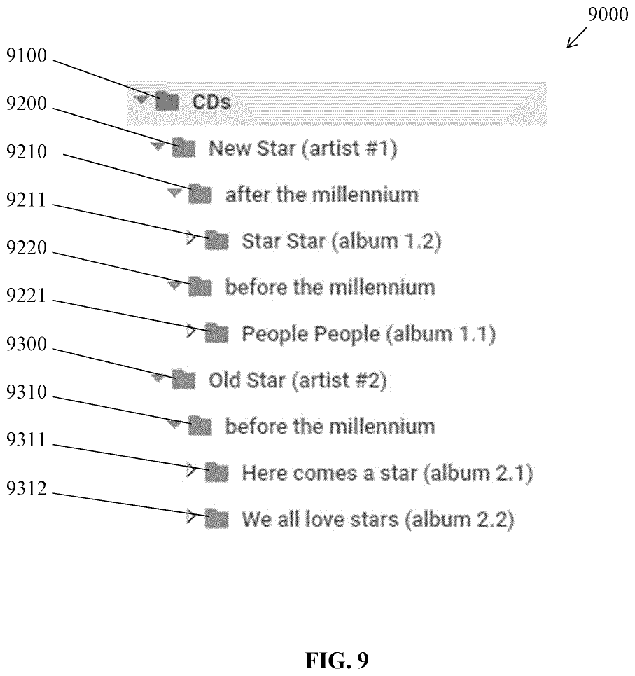

For example, in some embodiments, the number of results returned by a search query can be represented via a count provided in association with a search node, such as displayed at counts 2300 of search tree representation output display 2000 shown in FIG. 6. When subdividing an incipient search into further subsearches it is possible that a result will be captured by more than one subsearch, and such duplication information can be indicated for example by way of underlining 2310. Users may also benefit from separately displayed counts of folders and files returned by a search, such as folder count 2320 and file count 2330. However, in some embodiments display space or other restraints may preclude the addition of metadata or may indicate a need to provide only some types of metadata.

Without file count indicators, duplication indicators, and other metadata, it may be difficult for a user to catch the characteristics of a data collection or query.

As search tree representations are separate logical representations of a data collection from the underlying file storage trees, it may be that the underlying file collection is modified during a search or after a search has been stored for future use. When an underlying data collection is updated, the metadata associated with various nodes may need to be updated as well. However, in some embodiments this updating is not automatic but can be controlled by a user. For example, a user may set timed updates or may manually update or may set triggered updates. In some embodiments a node of a search tree representation may be created without being executed to determine metadata, such as an unsorted node created for logic and data integrity as a tree is built. As such, search tree representation nodes may have different update statuses at different times.

As indicated in TABLE 4 below, a set of possible status indications may include a representation showing that the search represented by the node has not yet been executed as shown in the left column, a representation that the node metadata has been updated since the last time the underlying data collection was updated as shown in the middle column, or a representation of node metadata in association with an indication that the node metadata has not been updated since the last time the underlying data collection was updated as shown in the right column.

TABLE 4
Example metadata status indicators

| | | |
|---|---|---|
| Not executed yet | Executed with no | Executed but collection |
| [symbol] [symbol] | recent update | has been updated |
| | [symbol] [symbol] | [symbol] [symbol] |
| (result set not | (summaries available | (summaries done but may |
| available) | and valid) | not be accurate any more) |

[symbol]

indicates data missing or illegible when filed

As running a search may be an expensive operation, computationally or otherwise, some users may prefer to only update a search when needed. It is to be understood that while TABLE 4 indicates the use of a question mark to represent uncertainty in the accuracy of displayed metadata, other indications can also be used, such as color or symbol-based schemes like borders, strike-throughs, or background colors or highlighting.

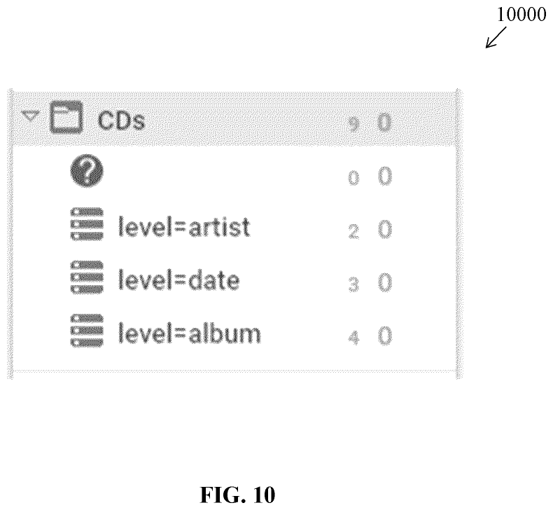

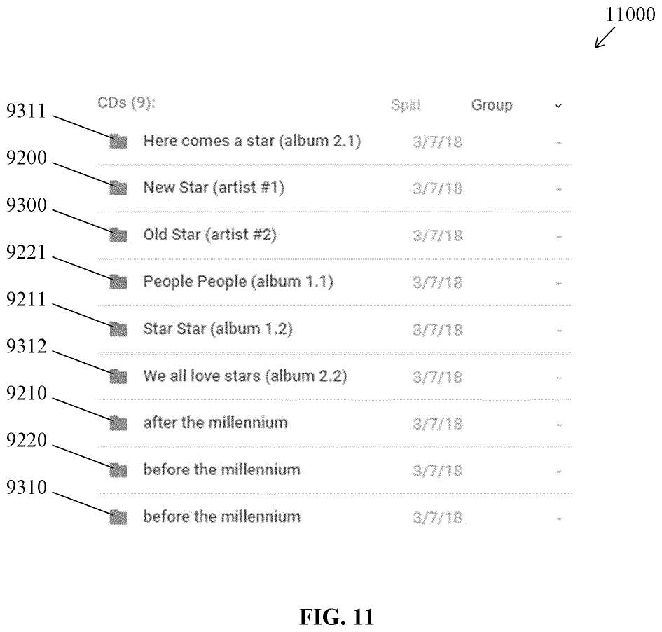

As indicated in FIGS. 7 and 8, in addition to representing the nodes of a search tree representation and metadata associated with each node, a search tree representation 2000 can also provide further information concerning overlapping results. When a user is notified of overlapping results, such as via underlining 2310, they may wish to know more about what result or results are overlapping. As indicated in FIG. 7 this information could be presented by way of a pop-up triggered by a mouseover event, the pop-up indicating the number of overlapped files or other information of a single overlapped result or other granular or collective information about a set of overlapped results.

The way in which search tree representations of a storage tree and associated data collection are depicted may vary according to different embodiments. Examples are indicated in FIG. 8, consisting of FIGS. 8A, 8B, and 8C. For example, a user could employ an underlining indication of an overlapping result such as in FIG. 8A, a scale-like vertical bar with actual file counts on the side and top as in FIG. 8B, a tree-map visualization indicating both hierarchical information and volume information using nested boxes or similar figures as in FIG. 8C, or may employ other depictions of a search tree representation and associated information.

As visualization methods may be difficult to use with complex tree node arrangements or with presenting metadata associated with nodes and hierarchical levels, the use of numbers and icons may be more convenient in some embodiments. In some embodiments, search tree representations may also indicate file size, file dates, average file sizes or other metadata, and may employ numbers, icons, pop-ups, maps, or other indicators to show the metadata. In some embodiments a user may be able to choose what metadata to be shown, which may depend on requirements or display or processing capability.

While a search tree can be a very helpful way to manage data and can represent a search request against a collection of data very well, some search requests may be better represented or displayed or visualized without breaking a data collection into further search nodes.

In some embodiments, groups of nodes within search or storage tree structures may be managed or examined or queried using a one-dimensional list of the data collection, displayed and used alone or in association with a search tree representation. The one-dimensional list may be sorted or re-organized or highlighted in response to queries or conditions or other controls to show or otherwise indicate inter-item relationships or aggregation information.

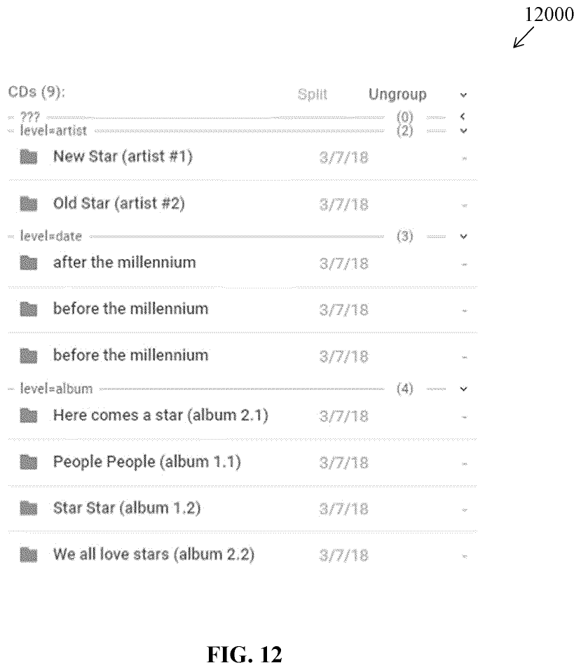

Shown in FIG. 9 is an example storage tree representation 9000, showing a top parent node 9100 purporting to represent a collection of music, a set of first-level child nodes 9200 and 9300 purporting to represent two music artists, a set of second-level child nodes 9210, 9220, and 9310 purporting to represent albums grouped by date, and a set of third-level child nodes 9211, 9221, 9311, and 9312 purporting to represent individual albums. Each node may or may not contain one or more files.

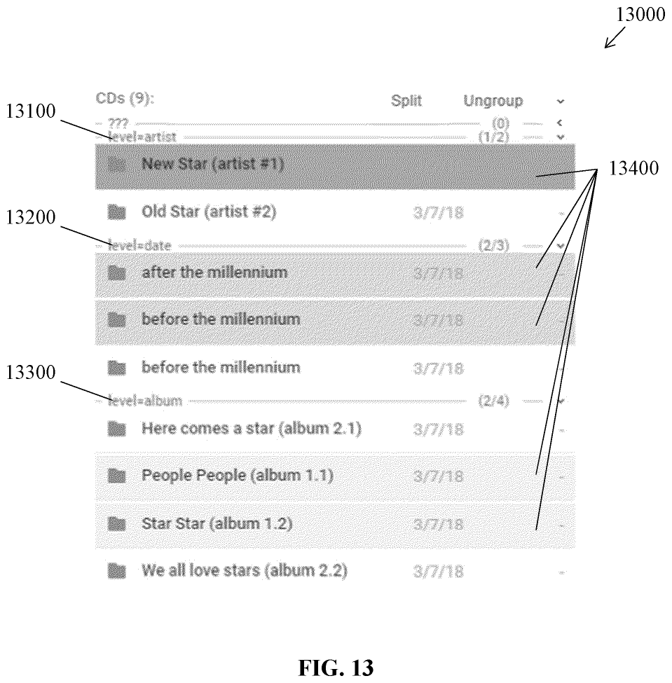

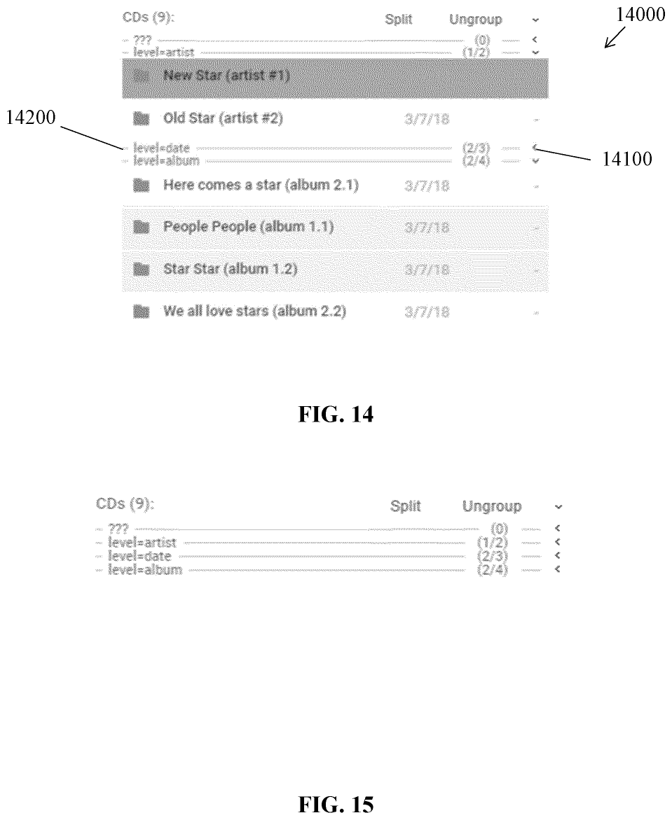

Shown in FIG. 10 is an example search tree representation 10000 of the storage tree representation 9000, implementing some of the disclosed search tree features discussed herein. Shown in FIG. 11 is a one-dimensional listing 11000 of each of the child nodes of storage tree 9000 in an unsorted listing, such as a listing which could be produced in response to the query ‘list all nodes within my CDs tree’. Unsorted lists allow a user to browse through a grouping of results. One-dimensional listings may make customized aggregations possible on an entire collection or subcollection of data items.

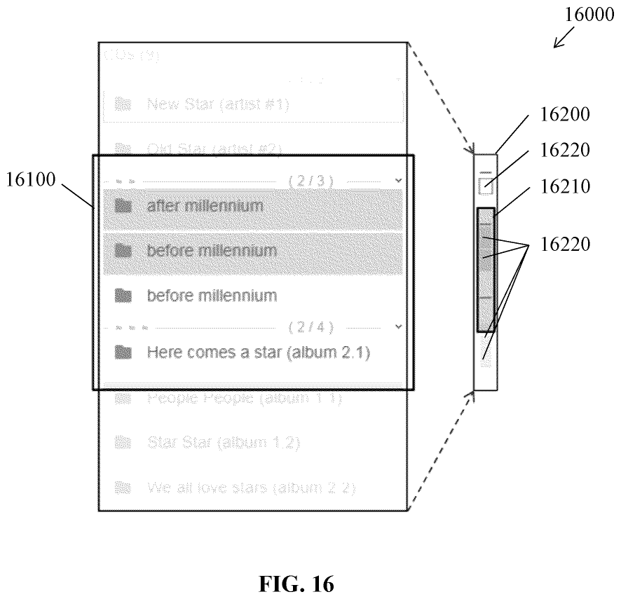

The unsorted list 11000 of FIG. 11 is shown in FIG. 12 as a sorted one-dimensional list 12000. One-dimensional lists which are sorted may allow a user to more easily browse through a grouping of results, or more easily locate a desired result or results, or more easily identify connections between data items. List 12000 is grouped according to hierarchical information from the associated search tree. Sorting could be automatic in some embodiments or may follow a user trigger or request. Sorting may be used both to flag connections between data items and to flag differences between data items.

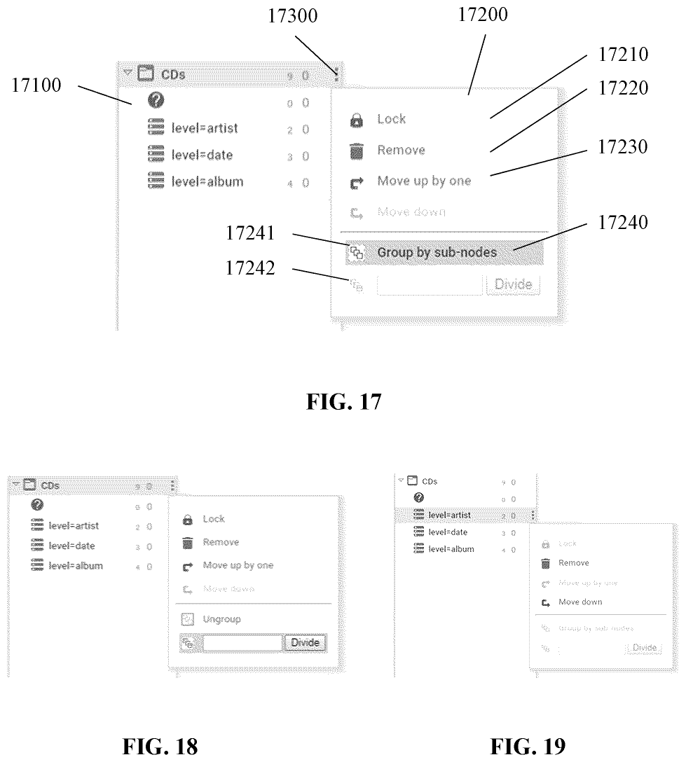

In some embodiments, a combination of sorting criteria could be applied. Multiple criteria could, for example, be used to distinguish one independent group from another or could be used to show relationships within groups. As an example, the data items of FIG. 12 are divided into independent groups of artist, date, and album, with no data items falling into more than one division. As another example, as indicated in FIG. 13, a list 13000 could be sorted by hierarchical level, such as into levels 13100, 13200, and 13300, and then the results returned by a further query could be highlighted, such as the highlighted set of results 13400. The highlighted set of results 13400 is returned as a result of the queries ‘how many albums are under the artist New Star’, resulting in a highlighting of the data item corresponding to the artist New Star and a highlighting of the data items in the date level corresponding to the artist New Star. The highlighted items also include those returned by the query ‘how many albums are under the artist New Star’, which resulted in the highlighting of the data items in the album level corresponding to the artist New Star. Alternatively, the same set of results could be highlighted in response to the query ‘which items correspond to artist New Star’.

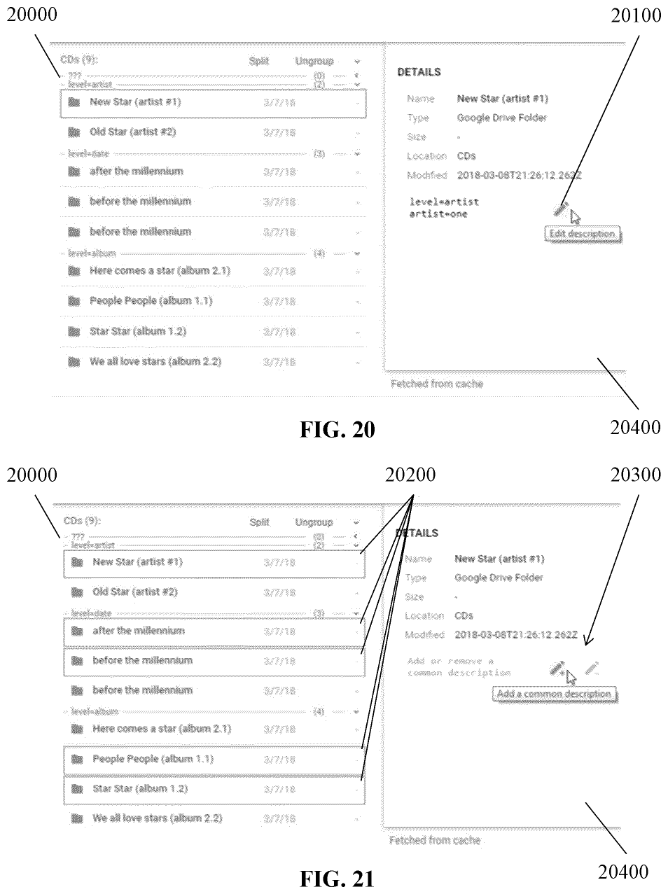

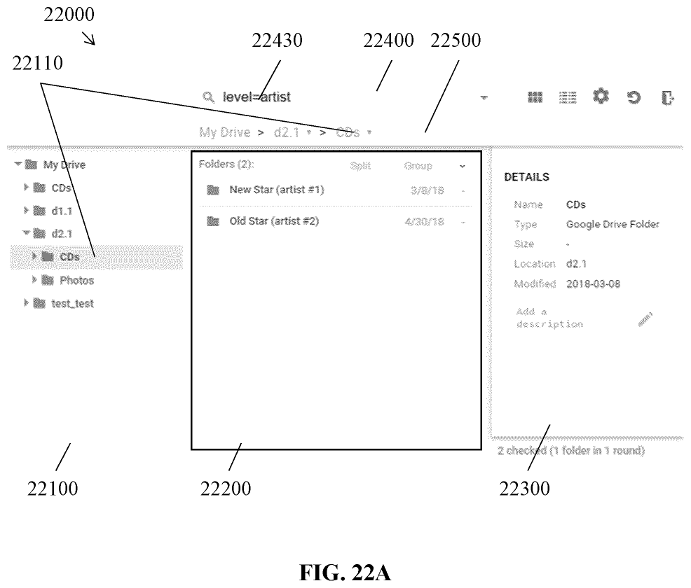

As indicated by the list 14000 of FIG. 14, a user can also choose to collapse a grouped set of data items to remove them from the set of data items displayed to the user without removing them from the set available for further display at a later point. The user may choose to use a toggle button, such as button 14100 to collapse a grouped level or set of results to a non-displayed set, such as indicated by header 14200, which can later be toggled back to a displayed configuration. As indicated in FIG. 15, the user can collapse up to all the groupings as desired, which may in some embodiments be a display of a search tree representation, allowing a search tree representation and a one-dimensional list of results to be provided in a common display panel.

In some embodiments the use of custom groupings and tree structures allows a user to add nodes which are not necessary for an underlying storage tree, such as nodes which reorganize a hierarchical level without further dividing the level or adding to the overall hierarchy. For example, grouping a set of music albums into date groupings when they are also separated by artist does not further subdivide the results when both subdivided at the same level, unless it is the results within an artist grouping that are further grouped by date. Allowing a user to add redundant groupings, either within a one-dimensional list or within one or more search tree representations which overlay a data collection, may allow a user to more easily see additional features, connections, or differences of and between data items in the data collection.

While the use of items grouped under headers and items flagged via highlighting is illustrated, it will be apparent that other methods of grouping results returned by queries can also be employed, such as headers, spacing, shading, the use of colors, the use of borders, the use of connecting lines, or other color- or symbol-based indicators. In some embodiments only one method of grouping will be available to a user, while in other embodiments a variety of methods of grouping will be available. However, in a preferred embodiment the user is at least able to group results by heading and then also flag the results of a further query within the heading-grouped list of results. The list may be sorted and divided and highlighted and flagged in groupings and sub-groupings as desired, as long as the logic remains comprehensible to the user.

In some embodiments a user may select a set of search results to view in a one-dimensional list in a variety of ways. For example, the user may select a node in a search tree to have all subnodes and other data items displayed in a list, and in some embodiments grouped by the subnodes. In another example, the user may access dedicated controls to indicate that they wish to review a set of data results in a one-dimensional list. In another example, the user may run a search and have the results highlighted in a list rather than having a representative node created.

In some embodiments the display of a collapsed one-dimensional list may be very similar to the display of a search tree, as may be seen for example by comparing the representation of FIG. 10 with the representation of FIG. 15. Such a display may enable a user to switch easily between a collapsed summarized overview and an expanded details list.

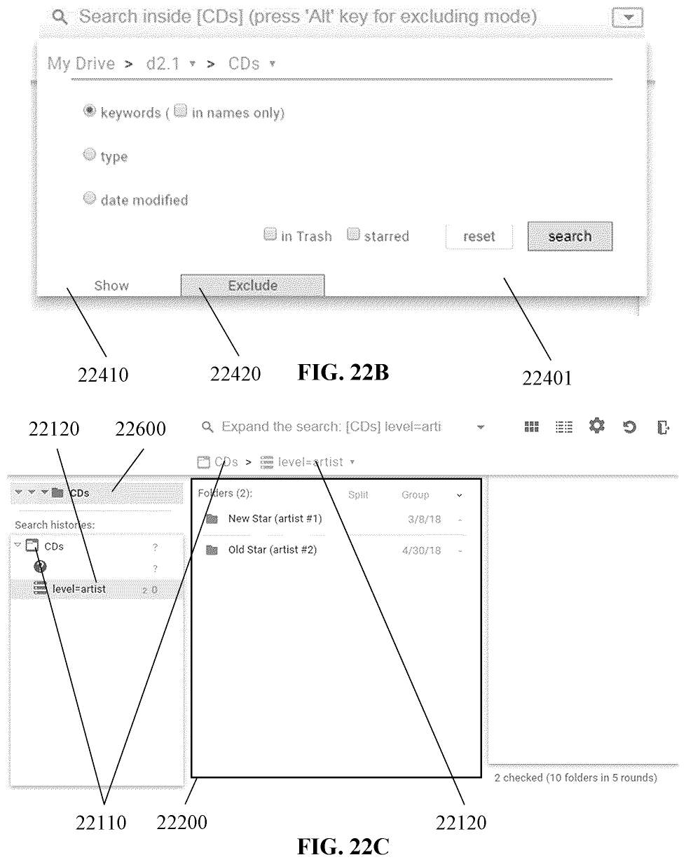

When a one-dimensional list is too large to conveniently fit in a display, in some embodiments a summary or projection of the total list may be provided to supply context information for what a user is viewing. For example, in FIG. 16 a user's display device may show only the portion indicated by view panel outline 16100 of the list 16000. To supply further information about the list as a whole, such as to give a user an idea of how many other items are in the list, where highlighted items are, where headings separating groups are, and how large the list is, the user may be supplied with list projection 16200. List projection 16200 may include a viewport location indicator 16210 and highlighted items indicators 16220 for example.

Listing items as a one-dimensional list and allowing a user to arrange and flag items in the list may allow users to more easily and visually spot relationships as the items are interleaved in a common display pane. It also may allow overlapping groupings to be shown together to enable a user to see multiple relationships. It also may allow groupings to be more clearly designated, such as by way of headers indicating the nature of a grouping. It may also allow groups to be more easily added and removed from review by use of a toggle or similar function to allow a user to hide a group of results. Like the use of search trees, such listings do not restrict the underlying data, and so may incorporate features in some embodiments to indicate the currency of the information provided. Such lists could also be provided based on a storage tree rather than a search tree.

The use of search trees, metadata display, and one-dimensional listing allows for easier organization, summarization, and review of a data collection to allow a user to run a great variety of queries and view a great variety of relationships.

In some embodiments, users may be able to freely switch between list and tree views of a search, or may be able to view both concurrently as indicated in FIG. 1, or may combine the two in a dropdown set of headings as indicated in FIG. 15. A compact representation of a storage tree as discussed herein may be deployed in some embodiments to free up additional display space.

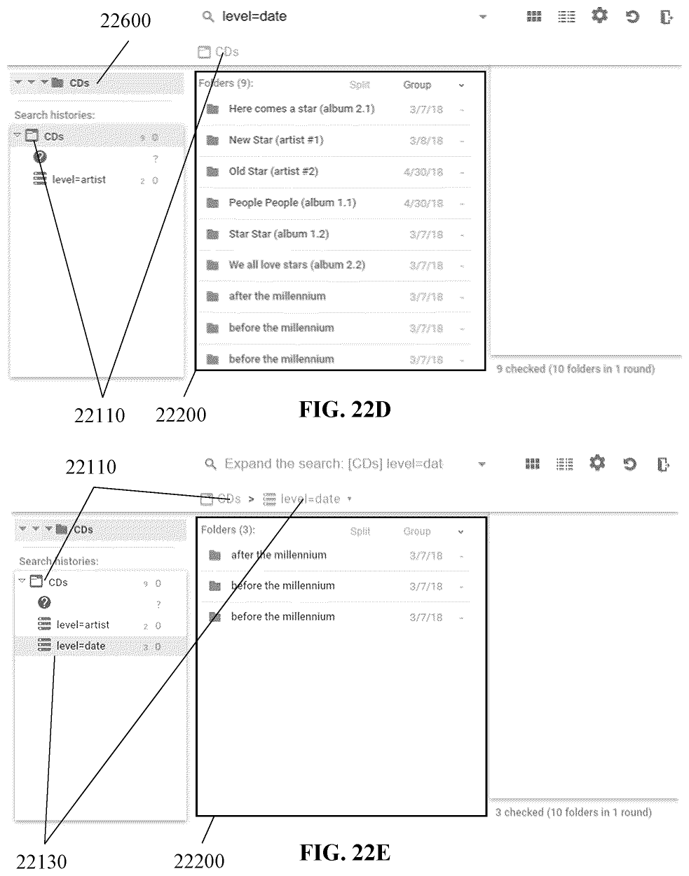

In some embodiments a user may be able to interact with a search tree representation or listing representation via a list of buttons or toggles. For example, such a list of buttons or toggles could allow the user to reconfigure the search tree, add to the search tree, display a listing of results of the search tree, reconfigure a listing of results represented by the search tree, or take other actions. For example, FIG. 17 shows a display of a search tree representation 17100 and shows a display of a dropdown list of options 17200 accessed by a user by selecting a toggle button 17300 on the display 17100.

The dropdown list of options 17200 allows a user to lock the tree or tree node from further editing via lock button 17210, such as to allow the tree, node, or listing to be accessible in the future for ongoing and unchanged reference. The list of options 17200 allows a user to remove a tree or tree node or collection of represented results in a listing of results via remove button 17220, such as to change the search tree or to adjust which results represented by a search tree are shown in a listing of results. The list of options 17200 allows a user to shift the position of a node or group of results via a set of move buttons 17230, such as to move a node up or down in a tree or to move a set of results relative to another set of results in a listing of results.

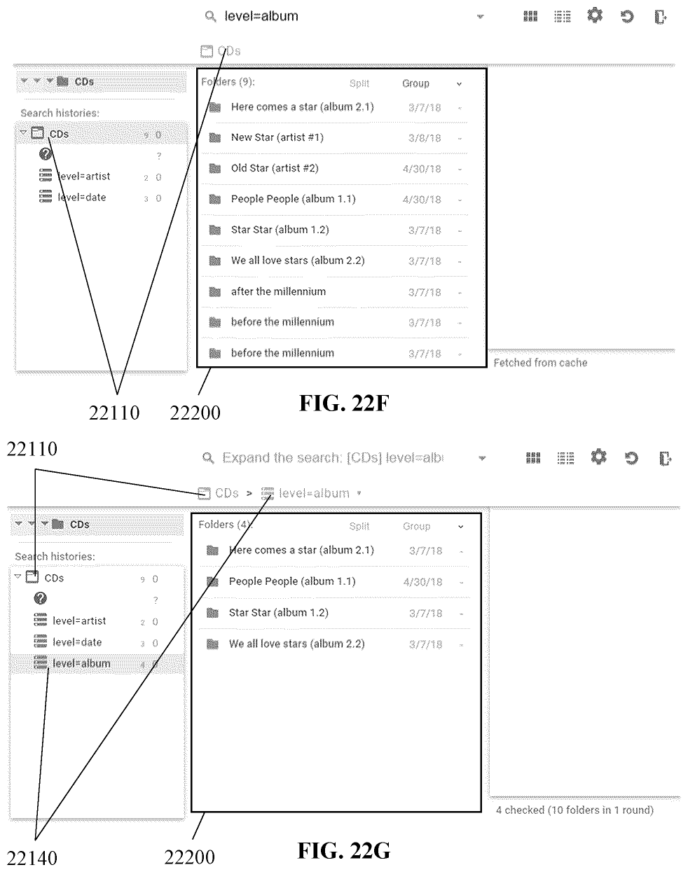

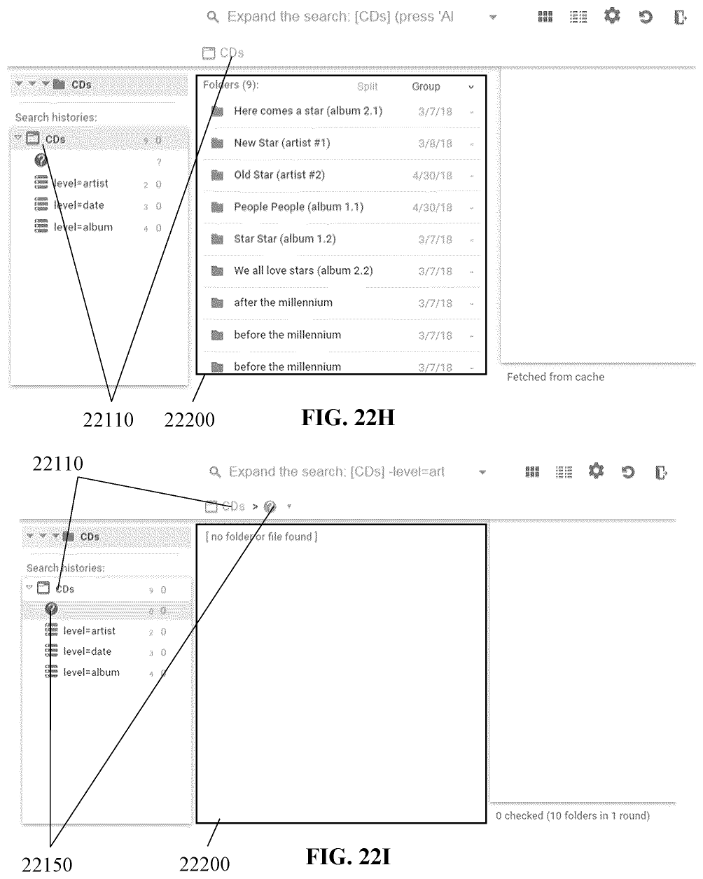

The list of options 17200 also allows the user to adjust groupings using a set of grouping buttons 17240, such as to choose which results are presented as a group separated under a header in a listing of results or to choose which results in a listing of results are highlighted or otherwise flagged. The set of group buttons 17240 may include a variety of options, such as allowing a user to group a collection of results via subnodes using a subnodes button 17241, or allowing a user to group a collection of results via a customized criterion using a text entry button 17242. Other options may also be provided to a user, as indicated in FIGS. 18 and 19; a user may be able to ungroup a set of grouped results, modify subnodes in a tree, or otherwise interact with a search tree or listing representation. Where an action is not available, such as moving a root node upward in a tree, the corresponding button may be removed from the listing or may be untoggleable or otherwise disabled.

In some embodiments, a display panel may include a details display area, such as details subpanel 1400 of display management interface 1000 of FIG. 1. The details panel can be used to show further information about a group, list, sub group, or data item, and in some embodiments a details display panel may be incorporated into the one-dimensional list display rather than being presented in a separate panel or area.

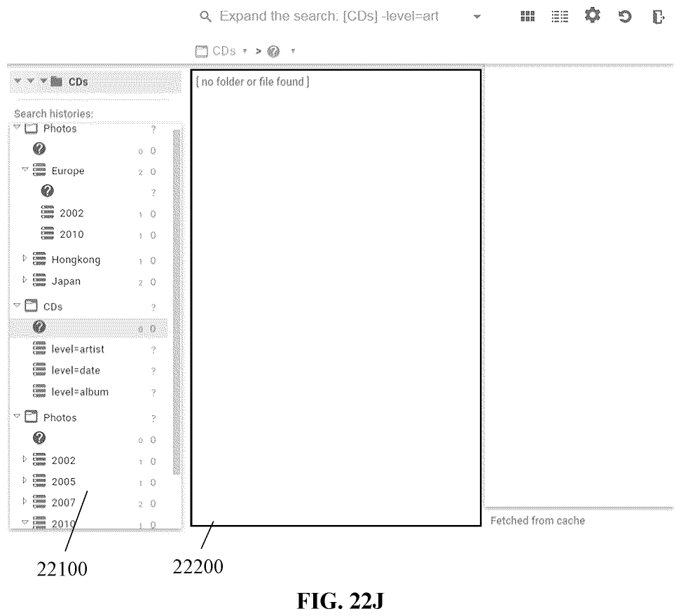

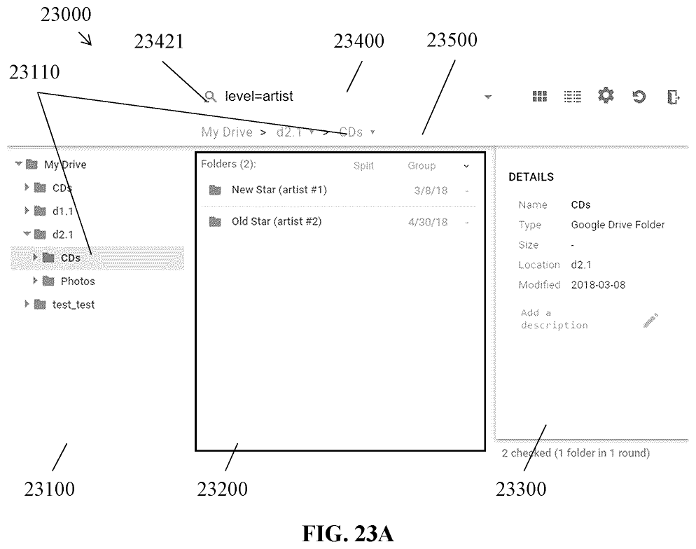

In some embodiments, a management system or interface or method may also allow users to add tags, such as using controls provided in a details subpanel of a display panel. For example, as depicted in FIGS. 20 and 21, a user may access a listing of results 20000, and may add a tag to an individual result, such as a file or folder, via a result editing button 20100. A user may also add a tag to a set of results, such as a selected set of files or folders 20200, via a set of result editing buttons 20300 in a details subpanel 20400. When adding tags to a set of results, in some embodiments a user may be provided with the option of associating a tag with the set as a group or associating the tag with each item in the group independently. Similar options may also be available for users to modify existing tags or to remove tags.

In some embodiments, the system may automatically detect whether a tag that a user is adding to a set of results is already added to one or more result in the set, and may add the tag only to results which are not already associated with the tag. In some embodiments, the system may apply conflict rules regarding which tags cannot be simultaneously applied to the same result or group of results, and may either notify a user of conflicts or automatically apply resolution rules.

Customized tagging can be a convenient and powerful way of managing files and folders in a data storage system; it allows arbitrary user-defined parameters to be associated with one or more data items and can help permit files to be distributed and redistributed for any collection in any desired order, such as using the search tree structure disclosed herein.

In some embodiments, a user is permitted to choose between a number of modes of forming a search tree. The choice of mode may affect how the user interacts with the interface, including what the user is presented with following the taking of certain actions such as issuing a query for the formation of a search tree. The choice of mode may also affect how the search underlying the interface presentation is conducted, as the choice of mode may affect the expense of the search that is needed to provide the user with the information they are expecting.

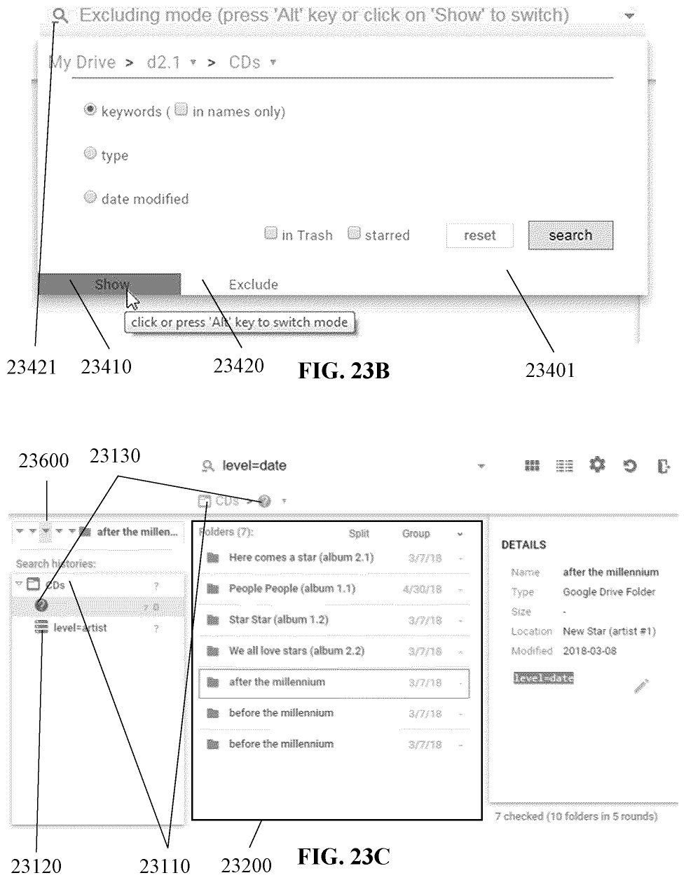

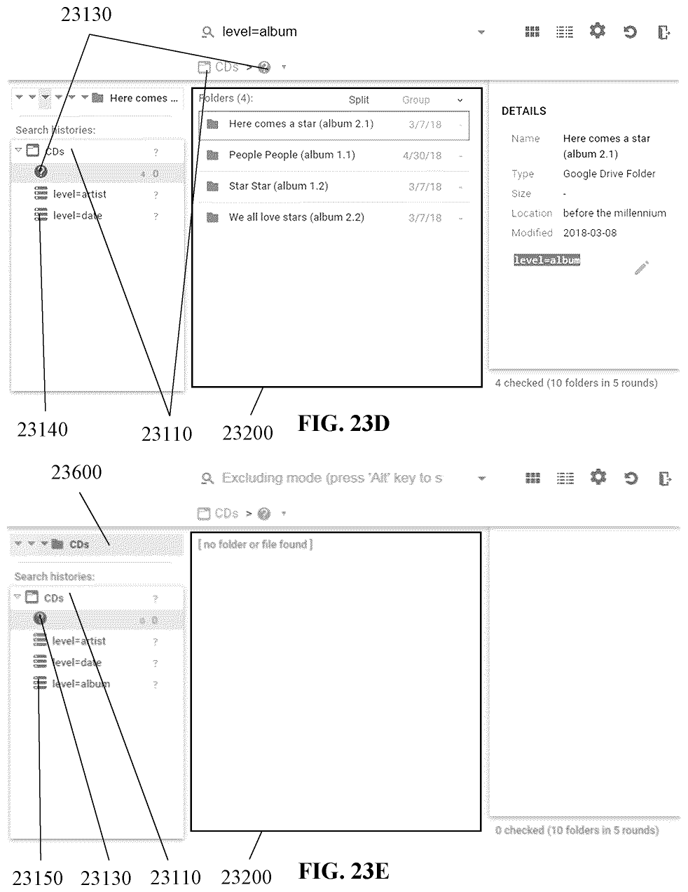

Two example modes are shown in FIGS. 22A to 22J and 23A to 23E, respectively. FIGS. 22A to 22J show an example construction of a search tree when a user is operating in a ‘show’ mode, which automatically presents the user with the contents of newly-formed search tree nodes following the issuance of a search query. FIGS. 23A to 23E show an example construction of a search tree when a user is operating in an ‘exclude’ mode which automatically presents the user with the contents of an automatically-formed or automatically-updated unsorted node or nodes following the issuance of a search query.

The exclude mode may be more appropriate when a user is not interested in seeing items that match their search, so much as seeing items which do not match their search. Different modes may present different advantages. For example, the ‘show’ mode may allow a user to easily identify what has been returned by a query, such as if they are trying to find a particular result. While the ‘exclude’ mode may allow a user to easily identify what contents of a parent node remain to be sorted, such as if they are trying to create a logically ordered search tree representation which accurately captures all results represented by the parent node.

FIGS. 22A to 22J depict interface or data management layout 22000 for creating and interacting with a search tree. As indicated in FIG. 22A, a user is presented with a data management layout 22000, the layout including a tree representation subpanel 22100, a contents subpanel 22200, a details subpanel 22300, and a search options subpanel 22400. The tree representation subpanel 22100 of FIG. 22A shows a storage tree representation including a selected parent node 22110, the contents of which are shown in the contents subpanel 22200.

Interface 22000 also includes a tree representation summary subpanel 22500. Where the tree representation is a search tree representation rather than a storage tree representation, such as in FIG. 22C, interface 22000 also includes a collapsed storage tree representation subpanel 22600.

The search options subpanel 22400 of FIG. 22A can be used to issue queries to form a search tree representation to replace the storage tree representation of FIG. 22A, and can be expanded into expanded search options subpanel 22401 of FIG. 22B when needed to provide a number of more advanced search interface options. For example, a user may search using keywords, results type, or date information. In the expanded search options subpanel 22401, the user has selected a ‘show’ mode using toggle tab 22410 of the tabbed toggle rather than an ‘exclude’ mode made available by toggle tab 22420. In some embodiments, a user is able to switch between ‘show’ and ‘exclude’ modes using keyboard shortcuts, such as by pressing the ‘aft’ key, in addition to or as an alternative to triggering a toggle. As described further below, an indicator is used to show the user of an unexpanded search options subpanel whether they would be searching in a ‘show’ mode or an ‘exclude’ mode.

The ‘show’ mode results in a user being presented in contents subpanel 22200 with the contents of a child node created by their refinement search, while the ‘exclude’ mode results in a user being presented in contents subpanel 22200 with the results left after their refinement search. As indicated in FIGS. 22C to 22J, a user operating in ‘show’ mode may enter a refinement search in a parent folder to create a basic search tree. In the example shown in FIGS. 22C to 22J, the user initiates a search tree by issuing the query for “level=artist” 22430 when using a ‘CDs’ folder as a parent folder. Having indicated a refinement search by artist, the user is then presented with a listing of the different artists located; namely New Star and Old Star as indicated in the contents subpanel 22200 of FIG. 22C. Contents subpanel 22200 of FIG. 22C shows the same contents as in FIG. 22A because the parent node 22110 in the storage tree representation was further organized by artist, just as the parent node 22110 of the search tree representation of FIG. 22C is.

If the user then wishes to add a further child node to the search tree at the level of child node 22120, they must perform a further refinement searches of the results represented by parent node 22110. In the embodiment of FIGS. 22A to 22J the user is required to return in the interface to the parent node by selecting the parent node 22110 as indicated in FIG. 22D. The user is then presented in the contents subpanel 22200 with the contents represented by the parent node of the search tree, and the user can choose a further query to run to create a further child node of parent node 22110.

As indicated in FIG. 22D the user may then enter the search query “level=date”, and as shown in FIG. 22E a new child node 22130 is created and the contents represented by child node 22130 are shown in contents subpanel 22200.

As indicated in FIGS. 22F and 22G, the same steps may be taken to form child node 22140 for the query “level=album”. The user may then return to the parent node 22110 as indicated in FIG. 22H, realize that no further queries are needed to capture represented contents, confirm this by selecting unsorted node 22150 as shown in FIG. 221 and seeing that there are no contents of the unsorted node 22150, and then conclude that the construction of the subject search tree representation is complete, at which point they may expand the tree representation subpanel as shown in FIG. 22J to view other established search or storage tree representations.

However, in some embodiments an ‘exclude’ mode may be used instead of the standard mode when forming a search tree. A search tree construction is indicated in FIGS. 23A to 23E, in which a user has selected an exclude mode using toggle 23420 as shown in FIG. 23B.

As may be apparent from the preceding, when a user is attempting to structure a logical search tree representation of a collection of items, the ‘show’ mode may be inefficient as the user is required each time a search is conducted to return to the parent node to see what other searches could be usefully conducted and for all subsequent searches to be recognized and placed at the same level under the parent node as the first search. Being presented with a list of unsorted results instead may allow a user to more efficiently choose a further query to issue to create a complete logical search tree representation.

As in FIGS. 22A to 22J, FIGS. 23A to 23E show an interface 23000 for creating and interacting with a search tree. As indicated in FIG. 23A, a user is presented with a data management layout 23000, the layout including a tree representation subpanel 23100, a contents subpanel 23200, a details subpanel 23300, and a search options subpanel 23400. The tree representation subpanel 23100 of FIG. 23A shows a storage tree representation including a selected parent node 23110, the contents of which are shown in the contents subpanel 23200. As indicated in FIG. 23A, an indicator 23421 may be provided to indicate that a search performed in search options subpanel 23400 would be performed in an exclude mode.

Interface 23000 also includes a tree representation summary subpanel 23500. Where the tree representation is a search tree representation rather than a storage tree representation, such as in FIG. 23C, interface 23000 also includes a collapsed storage tree representation subpanel 23600.

The search options subpanel 23400 of FIG. 23A can be used to issue queries to form a search tree representation to replace the storage tree representation of FIG. 23A, and may be expanded into expanded search options subpanel 23401 of FIG. 23B to provide a number of more advanced search interface options. For example, a user may search using keywords, results type, or date information. In the expanded search options subpanel 23401, the user has selected an ‘exclude’ mode using toggle 23420 rather than a ‘show’ mode made available by toggle 23410. As in FIG. 23A, an indicator 23421 is provided to indicate that a search performed in search options subpanel 23401 would be performed in an exclude mode.

The ‘exclude’ mode results in a user being presented with the contents of a parent node of a search tree representation that are not captured by any sorted child node; it defaults to showing the user the unsorted node and unsorted node's contents following a query issuance.

As indicated in FIGS. 23C to 23E, a user may enter a series of refinement searches in a parent folder to create a basic search tree. In the example shown in FIG. 23C, the user creates child node 23120 by issuing the query for “level=artist”, resulting in the automated creation of unsorted child node 23130. Following the search, instead of being shown the contents of the new sorted child node 23120, the user is shown the contents of unsorted child node 23130.

Similarly, as indicated in FIGS. 23D and 23E, respectively, the user may issue queries “level=date” and “level=album”, resulting in the creation of child nodes 23140 and 23150, respectively. Each time a new child node is created, the contents remaining under unsorted child node 23130 are reduced, until none remain as shown in FIG. 23E.

In some embodiments, the underlying processing required to form a search tree in an ‘exclude’ mode of formation is also modified. As running searches can be computationally expensive or otherwise expensive, in some embodiments in an ‘exclude’ mode a system does not return the results matching a search query to a user interface, rather it returns only those results which do not match any search query that has thus far been run; it returns the results matching an unsorted node or nodes. The search query represented by the unsorted node or nodes is executed and evaluated against the data collection in some embodiments.

As indicated above, in some embodiments a user may wish to regularly or easily switch between modes. In some embodiments a keyboard or other shortcut is provided, such as to allow a user to switch from having a search execute under a standard mode to having the search execute under an exclude mode by hitting the ‘aft’ key while the search subpanel is selected. In some embodiments a user interface includes an icon or other notification of which mode is operative.

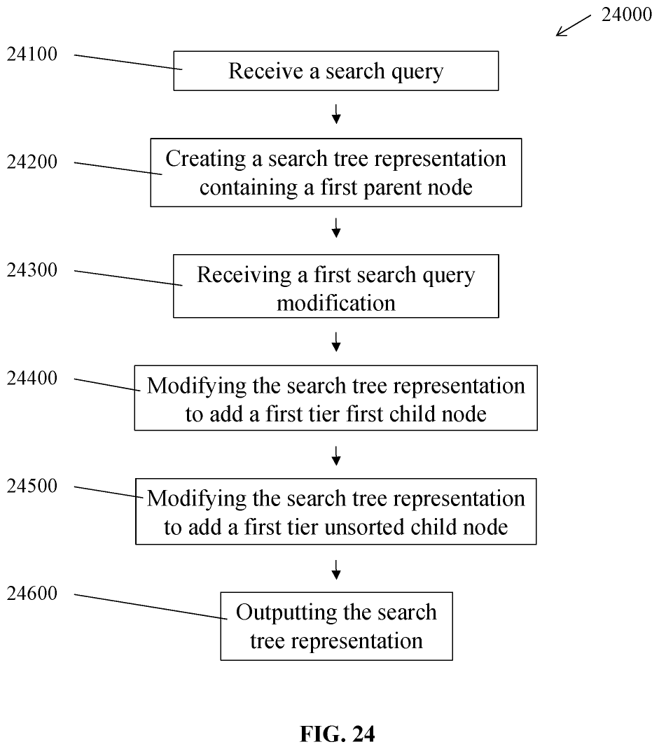

The process of forming a search tree representation will involve a series of steps. In the embodiment depicted in FIG. 24, a search tree representation is formed in a computer using the series of steps 24000. The computer may be configured so as to be able to output the search tree representation, such as via a display or to a storage or memory, and may be configured to be able to access a storage tree and associated collection of data which the search tree representation is meant to represent.

In the series of steps 24000, at step 24100 a search query is received in the computer, such as an electronic search query containing one or more terms or non-term conditions for searching through the storage tree and associated collection of data items. In the series of steps 24000, at step 24200 a search tree representation of the storage tree and associated collection of data items is created, the search tree representation containing a set of nodes including a first parent node representing the search query received in step 24100.

In the series of steps 24000, at step 24300 a first search query modification is received, such as a first search query modification modifying the search query to add a first term or non-term condition. In the series of steps 24000, at step 24400 the search tree representation is modified to add a first tier first child node to represent the first search query modification. In the series of steps 24000, at step 24500 the search tree representation is modified to add a first-tier unsorted child node to represent the search of the first parent node less the modified search represented by the first tier first child node. In the series of steps 24000, at step 24600 the search tree representation is output, such as displayed on a display cooperatively coupled to the computer on which the search tree representation is created and stored.

It is to be understood that the series of steps 24000 is an example series of steps, and many other embodiments will include one or more modifications, additions, or rearrangements of steps. For example, in some embodiments a user may add more than one first tier sorted child node. Further sorted first tier child nodes may be added in much the way the first tier first child node is added. Each time an additional first tier sorted child node is added, the unsorted child node may be modified to represent the search of the parent node less the searches represented by the collection of first tier sorted child nodes. In some embodiments, a user may further add second or subsequent tiers, with each tier containing at least one set of child nodes branching from a common parent node and including an unsorted child node.

In some embodiments, more than one unsorted child node may be formed automatically in a group of child nodes depending from a common parent node. For example, in some embodiments some search query modifications may make it conceptually appropriate to add more than one unsorted node, such as adding two unsorted nodes when a search query modification is a date range; one unsorted child node to represent results of the parent node which are from before the date range and one unsorted child node to represent results of the parent node which are from after the date range.

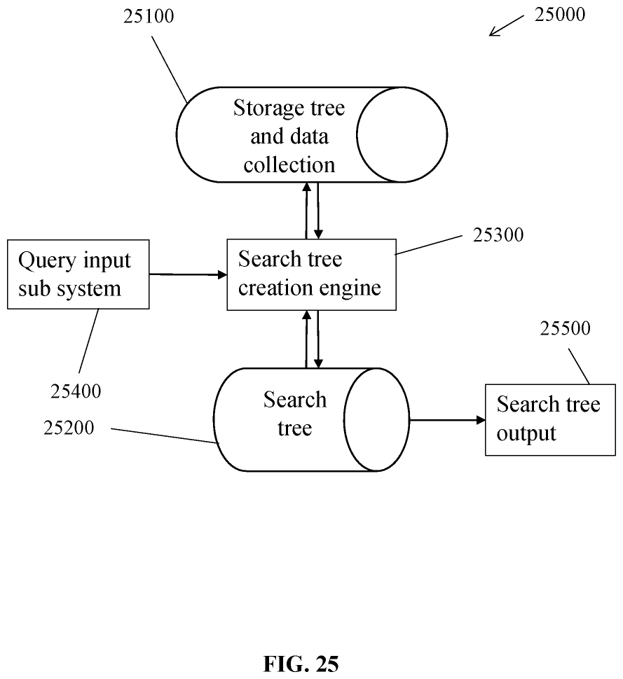

In some embodiments, such as depicted in FIG. 25, a system is employed to create a search tree representation. FIG. 25 depicts example system 25000, including a storage device 25100 for storing a storage tree and associated data collection, and also including a storage device 25200 for storing instructions for running the system and for storing a created search tree representation. System 25000 includes a search tree creation processor or engine 25300, which receives input from a query input subsystem 25400. Query input subsystem 25400 may include for example a keyboard and mouse to permit a user to enter a search query term or non-term condition for use as a search query. System 25000 also includes a search tree output 25500, such as a display or a further storage system or device.

In some embodiments, storage of information may be split as in system 25000 into storage of a search tree and data collection on one storage device and storage of a search tree representation on another storage device. In some embodiments storage of information may be on a common device. In some embodiments, storage of information may be distributed arbitrarily, via cloud storage or other network storage.

A search tree creation engine receiving input from a user may be run on a single processor, such as depicted in system 25000, or may also be distributed, such as via cloud processing or other network processing. In some embodiments, connection to the storage tree and associated data collection may not be necessary for forming a search tree representation, such as when metadata is not required or not required right away. In other embodiments, it is necessary that the computer be configured to connect to a storage containing a folder tree and associated collection of data in order for a created search tree to be used to manage the data collection.

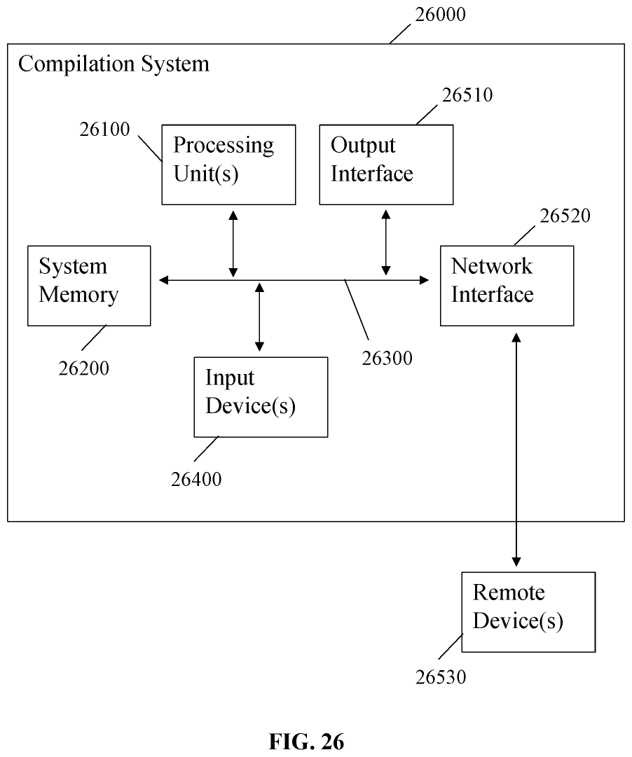

As depicted in FIG. 26, a compilation system, which may include a mobile device, accepts user search queries to be formed into a search tree representation. The system then forms a search tree representation using the search queries, and in some embodiments, it runs the search queries against a storage tree and associated data collection, such as to populate metadata entries on a search tree representation when required.

Embodiments of the present invention may be implemented using devices, such as the computer compilation system depicted in FIG. 26. The computer compilation system may execute computer instructions to perform steps involved in accessing the storage tree and associated data collection, accepting search queries and search query modifications, forming a search tree representation of the relationships between search queries and search query modifications, automatically forming and updating unsorted child nodes, and presenting search tree representations to a user or otherwise outputting search tree representations.

As depicted in FIG. 26, a computer compilation system 26000 may include a processing unit 26100 and a system memory 26200 which may be interconnected across a system bus or network 26300. The computer compilation system 26000 may have access to computer readable media, and the system memory 26200 may include computer readable storage media in the form of volatile and/or non-volatile memory such as read-only memory and/or random-access memory. In some embodiments system memory may include an operating system, application programs, and program data.

A user using the computer compilation system depicted in FIG. 26 may interface with the computer through input devices 26400, such as a mouse or keyboard or touchscreen, to provide information and instructions. A user may receive information from the system from output devices, such as a monitor or network 26510 or output interface 26520, to receive media files or search tree representations or other items or content. In some embodiments a computer compilation system may be networked and operable as a distributed system, a computer compilation system may also be able to access distributed databases 26530 for information or processing capability.

Some embodiments may be implemented as a system, a method, or a computer program product. Accordingly, aspects of the invention may take the form of an entirely hardware embodiment, an entirely software embodiment (such as including firmware and resident software) or an embodiment combining software and hardware aspects. Aspects of some embodiments may take the form of a computer program produced embodied in one or more computer readable medium having computer readable program code embodied therewith.

Various embodiments of the invention have been described in detail. Since changes in and or additions to the above-described best mode may be made without departing from the nature, spirit or scope of the invention, the invention is not to be limited to those details but only by the appended claims.

What is claimed is:

1. A non-transient computer-readable medium containing computer-readable instructions which, when executed by a computer processor, perform a method of:
receiving from a user an electronic search query in a computer, the search query containing one or more terms or non-term conditions for searching through a storage tree and associated collection of data items;
creating in the computer a search tree representation of the storage tree and associated collection of data items, the search tree representation containing a set of nodes including a first parent node representing the search query;
receiving from the user an electronic first search query modification request in the computer, the first search query modification request modifying the search query to add a first term or non-term condition;
modifying the search tree representation in the computer to add a first tier first child node to the set of nodes, the first tier first child node connected to the first parent node and representing the first search query modification; and
automatically updating the search tree representation in the computer to add an at least one first tier unsorted child node to the set of nodes, the at least one first tier unsorted child node connected to the first parent node and representing the search query less the first search query modification.

2. The medium of claim 1, wherein the method further includes the steps of:
receiving from the user an electronic second search query modification request in the computer, the second search query modification request modifying the search query to add a second term or non-term condition;
updating the search tree representation in the computer to add a first tier second child node to the set of nodes, the first tier second child node connected to the first parent node and representing the second search query modification;
updating the search tree representation in the computer to update the at least one first tier unsorted child node to represent the search query less the first search query modification and less the second search query modification; and
outputting the search tree representation.

3. The medium of claim 1, wherein the method further includes the step of adding a set of metadata to each node of the set of nodes of the search tree representation prior to outputting the search tree representation.

4. The medium of claim 3, wherein the set of metadata includes a data items count.

5. The medium of claim 3, wherein the set of metadata includes a folder count and a file count.

6. The medium of claim 3, wherein the set of metadata includes a currency indicator showing whether the set of metadata has been updated since the storage tree and associated collection of data items was last updated.

7. The medium of claim 3, wherein the set of metadata includes an indication of overlapping results.

8. The medium of claim 1, wherein the method further includes providing an expansion toggle in association with an at least one node of the set of nodes prior to presenting the search tree representation on the display, the expansion toggle provided to expand the at least one node to provide a listing of results represented by the at least one node.

9. The medium of claim 1, wherein the method further includes outputting the search tree representation.

10. The medium of claim 9, wherein outputting the search tree representation includes presenting the search tree representation on a display.

11. The medium of claim 10, wherein presenting the search tree representation on a display includes presenting the search tree representation in a subpanel of a display panel, the display panel including at least one complementary subpanel.

12. The medium of claim 11, wherein the at least one complementary subpanel includes a compact storage tree representation.

13. The medium of claim 11, wherein the at least one complementary subpanel includes a listing of results subpanel containing a listing of query results, the listing of query results including a set of data items represented by an at least one selected node of the set of nodes of the search tree representation.

14. The medium of claim 13, wherein the at least one selected node is the first tier first child node.

15. The medium of claim 13, wherein the at least one selected node is the at least one first tier unsorted child node.

16. The medium of claim 13, further including physically or visually grouping the results of the listing of query results into a set of subgroup listings divided according to a set of grouping criteria.

17. The medium of claim 16, wherein the set of grouping criteria is a set of hierarchically equal nodes in the search tree representation.

18. The medium of claim 16, wherein the set of grouping criteria is a set of at least one user-entered search term or non-term condition.

19. The medium of claim 16, wherein the set of grouping criteria is a set of hierarchically equal nodes in the search tree representation and a set of at least one user-entered search term or non-term condition.

20. The medium of claim 16, wherein each subgroup of the set of subgroup listings is associated with a toggle to minimize the associated subgroup listing of the set of subgroup listings.

21. The medium of claim 16, wherein the listing of results subpanel also contains a projection of the listing of query results, the projection of the listing of query results showing the divisions of the set of subgroup listings.

22. The medium of claim 11, wherein the at least one complementary subpanel includes a details subpanel for showing details about a set of at least one selected result.

23. The medium of claim 22, wherein the details subpanel also includes a set of at least one editing option.

24. The medium of claim 23, wherein the set of at least one editing option includes a tag entering option to add an entered tag to each result of a set of selected results.

25. The medium of claim 23, wherein the set of at least one editing option includes a tag removing option to remove an entered tag to each result of a set of selected results.

26. The medium of claim 23, wherein the set of at least one editing option includes a tag replacing option to replace an entered tag to each result of a set of selected results.

27. The medium of claim 15, further comprising following outputting the search tree representation to a user:
receiving from the user an electronic second search query modification request in the computer, the second search query modification request modifying the search query to add a second term or non-term condition;
updating the search tree representation in the computer to add a first tier second child node to the set of nodes, the first tier second child node connected to the first parent node and representing the second search query modification;
updating the search tree representation in the computer to update the at least one first tier unsorted child node to represent the search query less the first search query modification and less the second search query modification; and
outputting the updated search tree representation.

28. The medium of claim 27, wherein outputting the updated search tree representation to a user includes presenting the user with an updated output presentation, the updated output presentation including at least an updated search tree representation subpanel and an updated contents subpanel, the updated search tree representation subpanel depicting an updated icon representation of the search tree indicating one node of the set of nodes as an updated selected node, and the updated contents subpanel depicting a listing of all items represented by the updated selected node.

29. The medium of claim 28, wherein the updated selected node is the at least one first tier unsorted child node.

30. The medium of claim 29, wherein the output presentation is a visual presentation provided via a display.

31. A computer-implemented method for presenting a search session of a storage tree and associated collection of data items to a user, comprising executed on a processor the steps of:
receiving from the user an electronic search query in a computer configured to be able to access the storage tree and associated collection of data items and configured to be able to access a display, the search query containing one or more terms or non-term conditions for searching through the storage tree and associated collection of data items;
creating in the computer a search tree representation of the storage tree and associated collection of data items, the search tree representation containing a set of nodes including a first parent node representing the search query;
receiving from the user an electronic first search query modification request in the computer, the first search query modification request modifying the search query to add a first term or non-term condition;
modifying the search tree representation in the computer to add a first tier first child node to the set of nodes, the first tier first child node connected to the first parent node and representing the first search query modification; modifying, without receiving from the user a further electronic request, the search tree representation in the computer to add an at least one first tier unsorted child node to the set of nodes, the at least one first tier unsorted child node connected to the first parent node and representing the search query less the first search query modification; and
outputting the search tree representation.

32. The method of claim 31, further including:
receiving an electronic second search query modification request in the computer, the second search query modification request modifying the search query to add a second term or non-term condition;
modifying the search tree representation in the computer to add a first tier second child node to the set of nodes, the first tier second child node connected to the first parent node and representing the second search query modification;
modifying the search tree representation in the computer to update the at least one first tier unsorted child node to represent the search query less the first search query modification and less the second search query modification; and
outputting the search tree representation.

33. The method of claim 31, further comprising adding a set of metadata to each node of the set of nodes of the search tree representation prior to outputting the search tree representation.

34. The method of claim 33, wherein the set of metadata includes a data items count.

35. The method of claim 33, wherein the set of metadata includes a currency indicator showing whether the set of metadata has been updated since the storage tree and associated collection of data items was last updated.

36. The method of claim 33, wherein the set of metadata includes an indication of overlapping results.

37. The method of claim 31, further comprising providing an expansion toggle in association with an at least one node of the set of nodes prior to outputting the search tree representation, the expansion toggle provided to expand the at least one node to provide a listing of results represented by the at least one node.

38. The method of claim 31, wherein outputting the search tree representation includes presenting the search tree representation on a display.

39. The method of claim 38, wherein presenting the search tree representation on a display includes presenting the search tree representation in a search tree representation subpanel of a display panel, the display panel including at least one complementary subpanel.

40. The method of claim 39, wherein the at least one complementary subpanel includes a compact storage tree representation.

41. The method of claim 39, wherein the at least one complementary subpanel includes a listing of results subpanel containing a listing of query results, the listing of query results including a set of data items represented by an at least one selected node of the set of nodes of the search tree representation.

42. The method of claim 41, wherein the selected node is the first tier first child node.

43. The method of claim 41, wherein the selected node is the at least one first tier unsorted child node.

44. The method of claim 41, further including physically or visually grouping the results of the listing of query results into a set of subgroup listings divided according to a set of grouping criteria.

45. The method of claim 44, wherein the set of grouping criteria is a set of hierarchically equal nodes in the search tree representation.

46. The method of claim 44, wherein the set of grouping criteria is a set of at least one user-entered search term or non-term condition.

47. The method of claim 44, wherein the set of grouping criteria is a set of hierarchically equal nodes in the search tree representation and a set of at least one user-entered search term or non-term condition.

48. The method of claim 44, wherein each subgroup of the set of subgroup listings is associated with a toggle to minimize the associated subgroup listing of the set of subgroup listings.

49. The method of claim 44, wherein the listing of results subpanel also contains a projection of the listing of query results, the projection of the listing of query results showing the divisions of the set of subgroup listings.

50. The method of claim 39, wherein the at least one complementary subpanel includes a details subpanel for showing details about a set of at least one selected result.

51. The method of claim 50, wherein the details subpanel also includes a set of at least one editing option.

52. The method of claim 51, wherein the set of at least one editing option includes a tag entering option to add an entered tag to each result of a set of selected results.

53. The method of claim 51, wherein the set of at least one editing option includes a tag removing option to remove an entered tag to each result of a set of selected results.

54. The method of claim 5123, wherein the set of at least one editing option includes a tag replacing option to replace an entered tag to each result of a set of selected results.

55. The method of claim 43, further comprising following outputting the search tree representation to a user:
receiving an electronic second search query modification request in the computer, the second search query modification request modifying the search query to add a second term or non-term condition;
updating the search tree representation in the computer to add a first tier second child node to the set of nodes, the first tier second child node connected to the first parent node and representing the second search query modification;
updating the search tree representation in the computer to update the at least one first tier unsorted child node to represent the search query less the first search query modification and less the second search query modification; and
outputting the updated search tree representation.

56. The method of claim 55, wherein outputting the updated search tree representation to a user includes presenting the user with an updated output presentation, the updated output presentation including at least an updated search tree representation subpanel and an updated contents subpanel, the updated search tree representation subpanel depicting an updated icon representation of the search tree indicating one node of the set of nodes as an updated selected node, and the updated contents subpanel depicting a listing of all items represented by the updated selected node.

57. The method of claim 56, wherein the updated selected node is the at least one first tier unsorted child node.

58. A system for presenting a user interface, comprising:
at least one data memory storing a storage tree and associated collection of data items, the storage tree and associated collection of data items including a set of files and a set of folders;
at least one processor electronically coupled to the data memory for processing the set of files and the set of folders; and
a display for presenting a search tree representation, and
wherein the at least one processor is configured to receive the first search query for searching the storage tree and associated collection of data items, to generate a search tree representation including a root node representing the first search query, to receive a first search query modification of the first search query, to modify the search tree representation to include a first tier first sorted child node representing the first search query modified by the first search query modification, to modify the search tree representation to include a first tier first unsorted child node representing the first search query less the first search query modified by the first search query modification, and to output the search tree representation.

59. The system of claim 58, wherein the processor is further configured to search the storage tree and associated collection of data items to add metadata to the search tree.

60. The system of claim 58, wherein the processor is further configured to receive a second search query modification of the first search query, to modify the search tree representation to include a first tier second sorted child node representing the first search query modified by the second search query modification, and to modify the first tier first unsorted child node to represent the first search query less the first search query modified by the first search query modification and less the first search query modified by the second search query modification.

61. The system of claim 60, wherein the processor is further configured to search the storage tree and associated collection of data items to provide a listing of results represented by the search tree representation.

62. The system of claim 60, wherein the processor is configured to output the search tree representation to the display as a display panel, the display panel containing a set of subpanels, the set of subpanels including a search tree subpanel to display the search tree representation.

63. The system of claim 62, wherein the search tree subpanel is provided to display an icon representation of the search tree with one node of the search tree indicated as a selected node, the display panel further containing a contents subpanel depicting a listing of all items represented by the selected node.

64. The system of claim 58, wherein the processor is further configured to perform an exclusion search of the storage tree and associated collection of data items to provide a listing of results represented by the first tier first unsorted child node.

65. The medium of claim 1, wherein the method further includes the steps of performing an exclusion search of the storage tree and associated collection of data items and providing a listing of results represented by the first tier first unsorted child node.

66. The method of claim 31, wherein the method further includes the steps of performing an exclusion search of the storage tree and associated collection of data items and providing a listing of results represented by the first tier first unsorted child node.
